(19) United States
(12) Patent Application Publication
(10) Pub. No.: US 2002/0113352 A1
(43) Pub. Date: Aug. 22, 2002

(54) Shock absorbing structures

(76) Inventor: Mark Stephen Edwards, Hockessin, DE (US)

Correspondence Address: E I DU PONT DE NEMOURS AND COMPANY, LEGAL PATENT RECORDS CENTER, BARLEY MILL PLAZA 25/1128, 4417 LANCASTER PIKE, WILMINGTON, DE, 19805, US

(21) Appl. No.: 10/044,361

(22) Filed: Jan. 11, 2002

Related U.S. Application Data
(60) Provisional application No. 60/264,418, filed on Jan. 26, 2001.

(51) Int. Cl. F16F 1/06

(52) U.S. Cl. 267/166

(57) ABSTRACT

A shock absorbing structure includes a body defined by a plurality of adjacent coils. The coils are resilient and flexible when exposed to a load applied substantially off-axis, or perpendicular to the axis of the body. In use, the body is positioned so that the coils deflect in directions substantially normal to the axis of the body. In this way, the body acts like a shock absorber, but unlike a coil spring, the shock is absorbed by the laterally inward or outward flexing of the coils, rather than the extension or compression of the coils themselves along their axis. The body can be formed by coiling a monofilament strand which is made of a polymeric material, such as nylon. Any number and types of articles can be made by incorporating the shock absorbing structures of the present invention, including, for example, articles of footwear, impact resistant bumpers, tires, and vibration dampening pads.

This application claims the benefit of U.S. Provisional Application No. 60/264,418, filed Jan. 26, 2001.

### BACKGROUND OF THE INVENTION

The present invention relates generally to support structures of the general type that absorb shock, and more specifically, support structures made of polymeric monofilament. A continuous length of monofilament is wrapped to form a tubular structure having a plurality of coaxially disposed wraps of desired shape. A particularly advantageous shape is circular. The circular wraps are individually capable of deforming under load, and springing back to their original shape, thus providing both support and shock absorption.

### DESCRIPTION OF THE RELATED ART

The art related to shock absorbing devices is old and well developed. For example, in the automotive field, steel is commonly used to form leaf springs and coil springs that are incorporated into the suspension systems of trucks and automobiles. Steel springs work on the principal that, when a metal object is deflected from its natural state, a spring force is generated which tends to restore the object to its prior disposition once the deflection force is removed. The deflection force, for example, can be a weight placed on a vehicle, wherein the weight causes a coil spring or a leaf spring to compress. For coil springs, the loading force is applied axially, meaning that the force vectors are parallel, if not collinear with, the axis of the spring.

Foam products are another class of shock absorbing devices. For example, in footwear, inner pads are made of cellular polymeric foams. The foam material provides a cushion against shock which otherwise translates from the ground to the foot of the wearer. While foam materials have several advantages, including relatively lightweight and inexpensive to manufacture, they also tend to compress over time and thus become less comfortable and less able to absorb shock. This phenomenon is partly or entirely due to the rupture of the foam's cellular structure and the compromised structural integrity of the polymeric material.

A further class of shock absorbing devices used in athletic shoes is the fluid filled cushion. These devices include bladders, inflatable with air or filled with a shock dampening jell or liquid, that are installed into the sole of the shoe. A wearer of the shoe, in some instances, can use a miniature air pumping bellows, incorporated into the shoe, to inflate a bladder during use.

While these bladders are capable of providing adequate shock absorption, they tend to be expensive to manufacture and to be prone to mechanical failure. Once a bladder develops a leak, for example, the entire shoe can become unusable, thus resulting in a significant financial loss to the wearer. Again, as with other shock absorbing devices, air or fluid filled bladders tend to have a limited life, determined by the number of shock cycles, or the number of times the shock absorbing medium is placed in stress.

### SUMMARY OF THE INVENTION

The present invention involves the creation of an entirely new class of shock absorbing materials made of polymeric monofilament string wound to form cylindrical shock absorbers which absorb shock laterally, or forces that are applied substantially normal to the axis of the shock absorber.

One particularly well-suited polymeric material which forms the monofilament is nylon. These monofilaments have been used to make a wide variety of products, including brush bristles, fishing line, and tennis racket strings. When these materials are wrapped to form a plurality of spaced apart loops, the loops are capable of compressing from a generally circular shape to an oblated shape. Once the deformation force, such as a weight, is removed, the monofilament loops spring back to their original shape.

The monofilament loops have the advantage that they can cycle repeatedly through loading and unloading cycles without undergoing a degradation in structural integrity.

Accordingly, a shock absorbing structure includes a body defined by a plurality of adjacent coils, wherein the body has a longitudinal axis, wherein at least some of the coils are resilient and flexible when exposed to a load applied substantially off-axis, and wherein the body is positioned in use so that the coils deflect in directions substantially normal to the longitudinal axis of the body.

In particular, the body is made of a continuous length of material, wrapped to form a plurality of coils. The coils are preferably circular in shape but may be of other shapes, including ovals, triangles or virtually any polyhedron. Coiled structures made from the wrapped length of material can be used in a wide variety of applications, including articles of footwear and shock absorbers for vehicles, impact bumpers, vibration dampening pads, etc. The preferred material for forming coiled structures is a polymeric monofilament, and within that class, the preferred materials are acetal, polyester and nylon.

Another aspect of the present invention is to form conventional, axially loaded coil springs out of plastic materials, such as acetal, nylon and polyester. In this sense, the invention is a new use (a spring or shock absorber) of a known material (any of the plastic materials that provide a shock absorbing characteristic).

These features and further objects of the invention will become more apparent from the following detailed description when taken in conjunction with the illustrative embodiments in the accompanying drawings.

### BRIEF DESCRIPTION OF THE DRAWINGS

FIGS. 1a-1c are side elevational views of a coil spring, illustrating in sequence the spring taking a compressive load, the spring in an unloaded condition, and the spring taking a tension load;

FIG. 2 is a side elevational view of a coiled structure according to the present invention;

FIG. 3 is an end view of the coiled structure of FIG. 2;

FIGS. 4A and 4B are end views showing, in sequence, an unloaded coiled structure of the present invention and a loaded coil structure of the present invention;

FIG. 5 is a side elevational view of a coiled structure according to another embodiment of the present invention;

FIG. 6 is an end view of the coiled structure of FIG. 5;

FIG. 7 is a side elevational view of a shock absorbing (or vibration dampening) structure according to the present invention;

FIG. 8 is an end view of the shock absorbing structure of FIG. 7;

FIG. 9 is a side elevational view of an article of footwear according to the present invention;

FIG. 10 is an end view of an embodiment of the present invention in which coiled structures are embedded in foam and used in the sole of an article of footwear, although the illustration could be of a variety of shock absorbing or vibration dampening articles according to the present invention;

FIG. 11 is a side elevational view of a shock absorber according to the present invention;

FIG. 12 is an end view of the shock absorber of FIG. 11;

FIG. 13 is a side elevational view of the shock absorber of FIG. 11, undergoing a compressive, external force which is substantially normal to the axis of the shock absorber;

FIG. 14 is an end view of the shock absorber of FIG. 11 undergoing the compressive, external force shown in FIG. 13;

FIG. 15 is a side view of the shock absorber of FIG. 11, undergoing an external force which is not perpendicular to the axis of the shock absorber, thereby generating a torsional restoring force;

FIG. 16 is a partial, side elevational view of a coil spring according to another embodiment of the invention;

FIG. 17 is a longitudinal sectional view of a shock absorbing structure according to another embodiment of the present invention;

FIG. 18 is a transverse sectional view of the shock absorbing structure of FIG. 17, taken along line 18-18 of FIG. 17;

FIG. 19 is a longitudinal sectional view of a variant shock absorbing structure according to another embodiment of the present invention, using spiral-wound coiled structures instead of straight coiled structures;

FIG. 20 is a transverse sectional view of the shock absorbing structure of FIG. 19, taken along line 20-20 of FIG. 19;

FIG. 21 is a perspective view of a monofilament ladder structure capable of use as a shock absorbing structure according to the present invention;

FIG. 22 is an end view of the ladder structure of FIG. 21;

FIG. 23 is an end view of an arched shock absorbing structure according to another embodiment of the present invention;

FIG. 24 is a radial, partial sectional view of a tire and arched shock absorbing structure according to the present invention;

FIG. 25 is a radial, partial sectional view of a tire and coiled shock absorbing structure according to the present invention; and

FIG. 26 is a side elevational view of a shock absorbing structure according to another embodiment of the present invention, in which a length of ladder structure is brought axial end to axial end, thereby forming a loop.

### DETAILED DESCRIPTION OF THE PREFERRED EMBODIMENTS

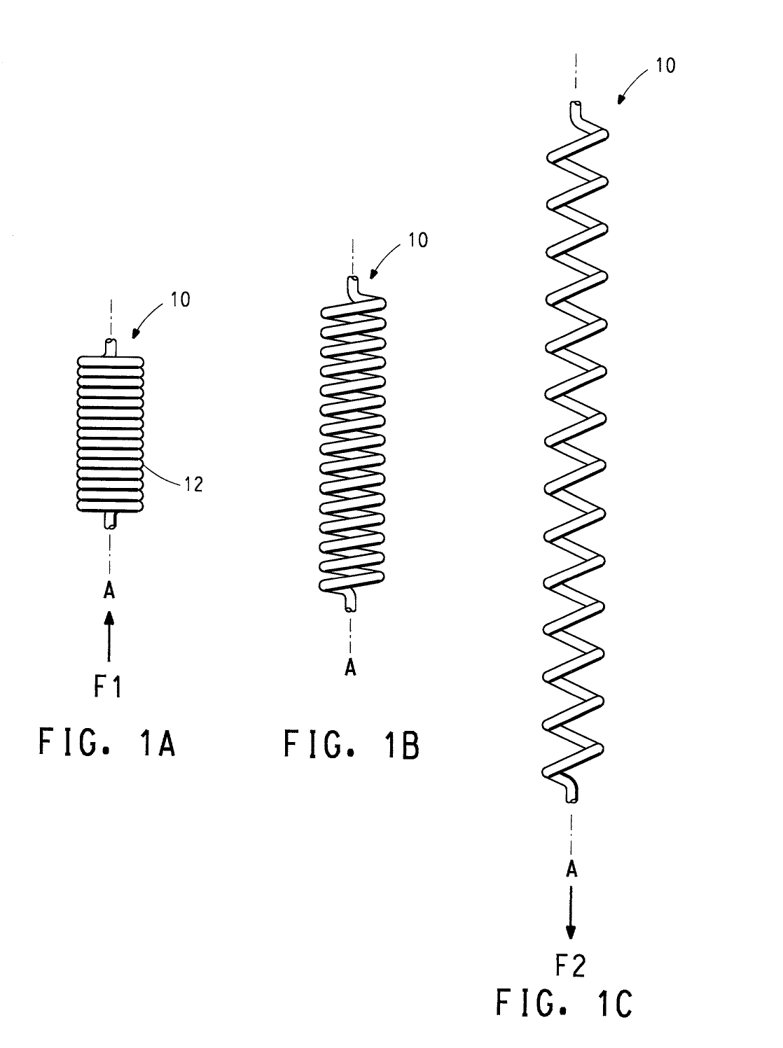

FIGS. 1A-1C illustrate a coil spring 10 in a compressed state (FIG. 1A), as would occur if an inward axial load was applied to either end of the spring 10. In such a condition, the individual coils 12 are in a “close-wound” condition, where adjacent coils are touching. When the compressive load is removed, and the spring is in an unloaded condition, the spring adopts the length shown in FIG. 1B, which is also called the “free length” of the spring. Shock absorbing force can be generated when the spring 10 is deflected away from its free length by either a compressive load or a tension load, as shown in FIG. 1C. In general, the coefficient of stiffness for extension and compression of the spring is what provides the shock absorbing characteristics of the spring 10; this characteristic is referred to as the spring constant, or stiffness constant designated by the letter “k.”

The axis “A” of the spring 10 is generally parallel to or coaxial with the compressive load or force F1, and the tension load or force F2. Coil springs commercially available of the form and function described above are typically made of a metal wire, such as a chromium silicon spring steel wire, for handling relatively substantial loads.

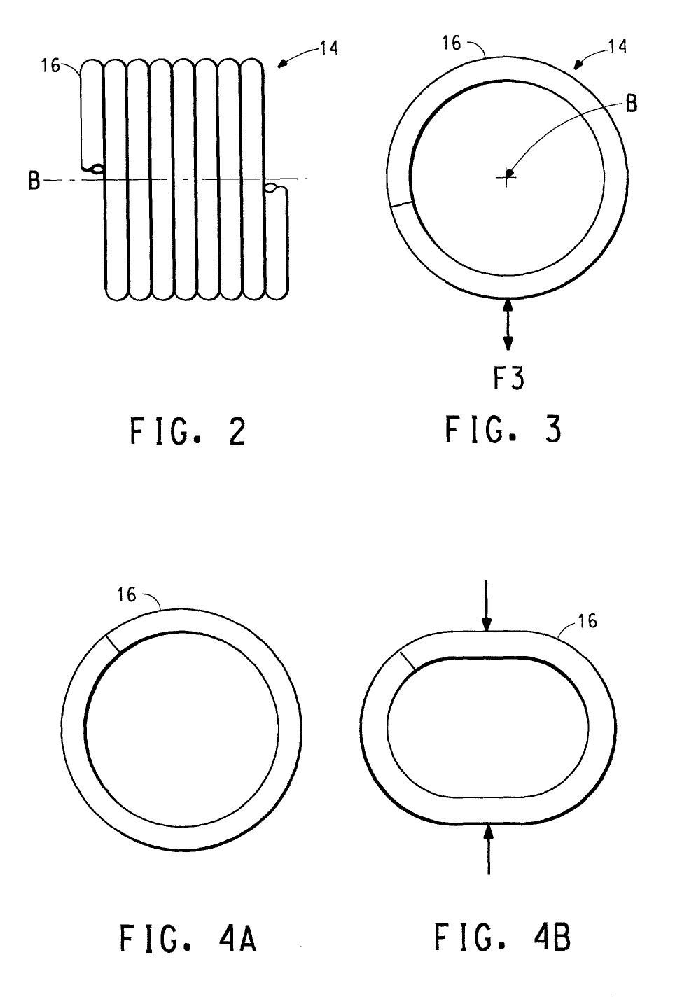

The present invention takes the conventional coil spring and turns it on its side, so that the individual coils act as shock absorbers when loads are applied in a direction substantially normal to the axis of the coils. As seen in FIG. 2, a coiled structure 14 of the present invention has a plurality of coils 16 disposed in close-wound, unloaded condition. The coils are coaxially disposed about the longitudinal axis “B” of the coiled structure. According to the invention, and as shown in FIG. 3, the coiled structure 14 receives a load or force F3 in a direction normal to the axis B of the coiled structure. The force F3 acts as a compression force when the force is directed towards the axis B, as for instance, when an object pushes against the structure 14. On the other hand, if the force is directed away from the structure, as for example, an object pulling against the side of the structure 14, the force F3 acts as a tension force.

As seen in FIGS. 4A and 4B, a coil 16 has a generally circular shape in the unloaded condition. When a load is applied in the direction shown in FIG. 4B, the circular shape flattens out under the influence of the force. The flattening of the coil generates a spring force that tends to restore the coil to its original shape after the force is removed. Materials can be selected so that the expected forces do not exceed the elastic limit of the material. In this manner, the coiled structure 14 functions as a shock absorber, cushioning the impact of a load applied to the coiled structure, which can be incorporated into virtually any shock absorbing application.

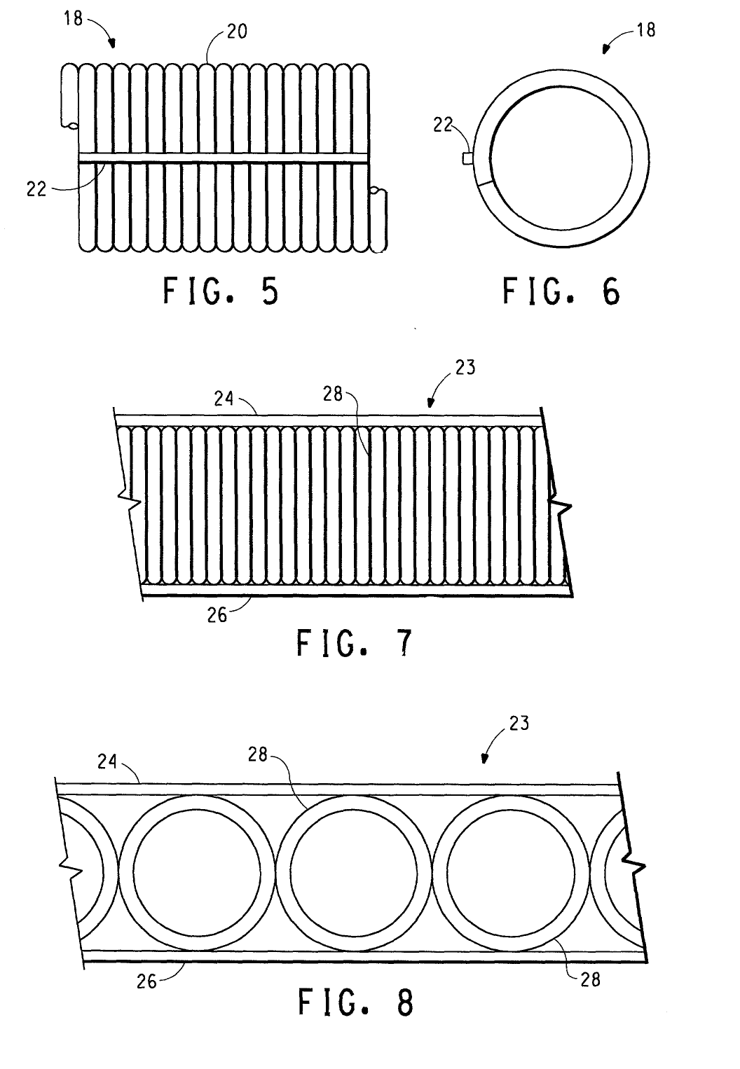

In one particularly preferred embodiment shown in FIGS. 5 and 6, a coiled structure 18 is made of a continuous length of polymeric monofilament which is wound to form a plurality of coils 20. In order to ensure that the wound monofilament maintains its coiled shape, at least one support string 22 can be ultrasonically bonded to the individual coils 20 in a continuous thermal bonding process of the type used in the assignee's prior co-pending applications describing methods and apparatuses for manufacturing bristle sub-assemblies. These applications include U.S. patent application Ser. Nos. 09/455,308, filed Dec. 6, 1999 and 09/092,092, filed Jun. 5, 1998, which are incorporated herein by reference.

These manufacturing techniques described in my co-pending applications describe wrapping a monofilament strand around a polygonal mandrel. To make coils, the mandrel can be cylindrically shaped. An alternative to using a base string to hold the coils in their coiled shape is to use a down-stream heat setting step in order to hold the monofilament in the coiled shaped. For larger diameter coils, it is also possible to use coil-shaped molds and inject thermoplastic or thermosetting material into the mold in a liquid state, and then subsequently allow the material to solidify.

To facilitate manufacture, the support string 22 is made of polymeric material which, under the influence of ultrasonic heating, bonds with material from the monofilament coils in a flow zone to thereby mechanically interconnect the coils and the support string. Other structures can be used to hold the coils together, and further function as a single, integrated structure. For example, as seen in FIGS. 7 and 8, a shock absorbing structure 23 includes a first member 24 and a second member 26, between which are disposed a plurality of coiled structures 28 which may be connected to or simply fitted between the first and second members 24 and 26. The members 24 and 26 may be rigid or semi-rigid, so that a load applied at any point along either member can be distributed among the plurality of coiled structures 28, and along the length of the individual structures. Conversely, the members 24 and 26 may be flexible, so that when a load is applied having an irregular surface in contact with either member 24 or 26, each coil 28 will respond individually and directly to the “localized” load. In addition, when members 24, 26 or both are flexible and an irregular load is applied over some length of a coiled structure 28, each individual coil segment along the length of the coiled structure will respond individually and directly to the load acting directly upon it.

In general, the monofilament can be any material that imparts a desired spring force when an appropriate load is applied. For light loads, relatively thin diameter “stiff” monofilaments or larger diameter, low modulus monofilaments can be employed. Conversely, for heavy loads relatively large diameter stiff monofilaments can be employed. It is recognized that in addition to the diameter of the monofilament, there is a relationship between the radius of curvature of the coils and the pitch of the helix forming the structure. For example, the spring structure illustrated in FIG. 2 shows the individual coils essentially in contact with each other, thus providing the minimum pitch of the structure. In contrast, FIG. 11 illustrates a spring structure wherein the pitch is such that the individual coils are spaced apart. With all other parameters the same, the structure illustrated in FIG. 11 would be less stiff because of the greater pitch. Essentially, the stiffness of the coil increases with reductions in radius or slower pitch of the helix. Also, stiffness increases with increases in the diameter of the monofilament. Within all diameters and radiuses, the precise selection of a type of polymeric material will have an impact on the overall stiffness of the coils. Thus, the diameter of the monofilament, the radius of the coils, the pitch of the coils and the type of material which comprises the monofilament are all selected to achieve a desired cushioning, or shock absorbing, effect. In other words, these parameters are varied to achieve a desired degree of stiffness or softness. Three particularly well-suited polymeric materials which form the monofilament are nylon, polyester, and acetal resins. Nylon monofilaments have been used to make a wide variety of products, including brush bristles, fishing string, and tennis racket strings. When these materials are wound to form a plurality of adjacent coils, the loops are capable of compressing from a generally circular shape to an oblated, or flattened circular shape. Once the deformation force, such as a weight, is removed, the monofilament coils spring back to their original shape. One particularly well-suited nylon material for making monofilaments is a nylon filament commercially available under the name TYNEX®, manufactured by E. I. DuPont de Nemours and Company of Wilmington, Del. USA. One particularly useful TYNEX® product is a 6,12 nylon filament made of polyhexamethylene dodecanamide. It has a melting point of between 208 and 215° C. and has a specific gravity of 1.05-1.07, and is available commercially in many cross-sectional shapes and diameters. Other suitable materials include HYTREL®, a polyester, and DELRIN®, an acetal resin. Both HYTREL® and DELRIN® are manufactured by E. I. DuPont de Nemours and Company of Wilmington, Del. USA and are commercially available. Chemically, an acetal is the product of a two-step reaction between an alcohol and an aldehyde. Acetal homopolymer which became commercially available in 1960 is formed by polymerizing anhydrous formaldehyde to make a chain of oxymethylene units. Celcon(r) acetal copolymer from Hoechst Technical Polymers (HTP) was introduced in 1961, and is prepared by copolymerizing trioxane with a cyclic ether into more chemically resistant chains comprised of oxymethylene and oxyethylene units. The copolymer is also offered by other manufacturers.

A particular application of the shock absorbing structure of FIG. 7 is in footwear. Traditionally, manufacturers of footwear have used one or more layers of foam materials between the ground and the foot to absorb the impact, and shock, of walking or running. Virtually every type or kind of footwear requires some form of shock absorption; typically it is a question of how thick and of what kind of materials. More recently, athletic shoes have employed inflatable bladders and/or liquid or jell filled bladders to absorb shock. While some of these may be effective, they all are subjected to a limited number of useful cycles before the shock absorbing function is degraded below an acceptable level.

Shock absorbers made using the laterally loaded coiled structures of the present invention are likely to undergo greater numbers of use cycles, and thus, the article of footwear will have a longer life. Referring to FIG. 9, an article of footwear 30 has an upper body 32 and a sole 34. The sole 34 includes a padded, shock absorbing structure which includes a plurality of the coiled structures 36 which may be disposed between the lower, traction surface of the sole and an upper, foot-supporting surface disposed within the article 30. As the wearer applies his or her weight to the sole of the article, as by standing, or accelerates that weight through walking or running, the impact of the weight, which is an applied load, is cushioned by the coiled structures. The individual coils will tend to respond by some degree of compression depending on the amount and location of the applied force; once the load is removed, the coils resume their original shape.

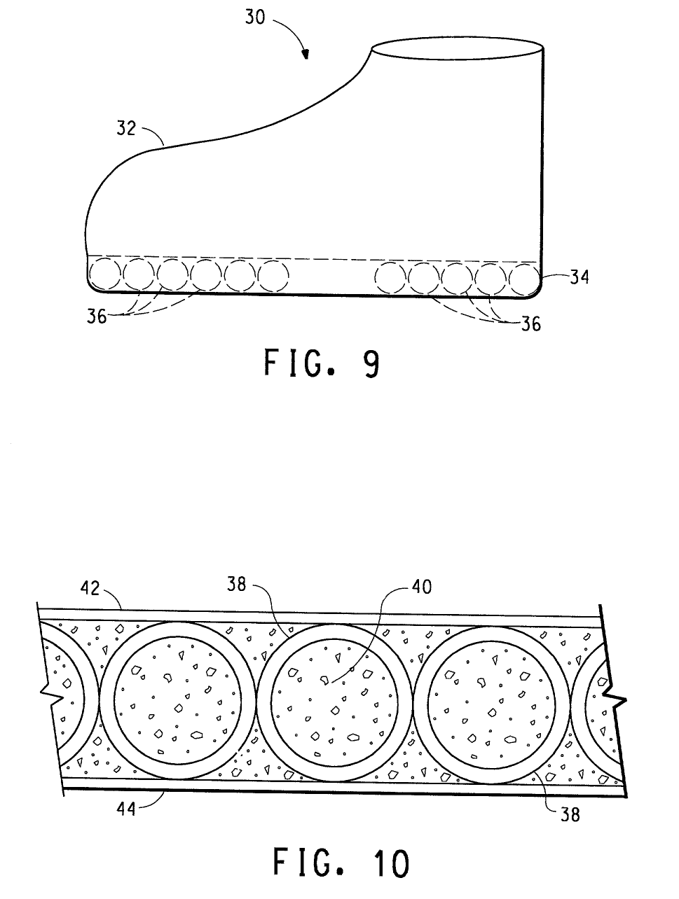

As shown in FIG. 10, and with reference to the articles of footwear, a plurality of coiled structures 38 may be embedded in a foam material 40, of the type traditionally used in the manufacture of footwear. These include both open-celled polymeric foam and closed-cell polymeric foam materials. In these instances, the coiled structures modify the shock absorbing capability of the foam and tend to reinforce and thus increase the useful life of the foam. The coiled structures are shown to be disposed between upper and lower members 42 and 44, which in the footwear context, may be flexible sheets of polymeric material or other materials that constitute portions of the sole. In other applications, as well as footwear applications, the foam 40 with embedded coiled structures 38 could be constructed as a single shock absorbing body, without other supporting members such as 42 and 44. The precise combination of layers, sheets, foams, and the number and location of the coiled structures, as well as their size and stiffness, are all selected for particular applications according to the amount of shock absorption or vibration dampening that is needed. It is also possible, in the polymeric monofilament embodiments, that the orientation of the coils can be held in place by the surrounding foam, which could be injection molded. Proper maintenance of the orientation of the coils is significant since the most effective absorption of shock occurs when the applied force is perpendicular, or normal, to the axis of the coil. Otherwise, the applied force would tend to cause the coil to tilt away from the applied force, rather than having the coil itself flex in the direction of the applied force, thus establishing a restoring, spring force which causes the coil to return to its unloaded position.

The coiled structures of the present invention can be used in virtually any shock absorbing environment, to replace conventional, axially loaded springs, leaf springs, or virtually any other type of spring. They can be used instead of gas-operated pistons and/or hydraulic cylinders in environments where those have been used. For example, bumpers on automobiles have in the past employed gas-operated shock absorbers which absorb shock and use the force of the shock to generate a restoring force that causes the bumper to return to its initial position once the shock force is removed. These applications are expected to require substantially thicker monofilaments than those used in footwear.

As described above, the principal restoration force, which tends to restore the coils to their unloaded condition, is a spring force developed by applying tension or compression to the coils in a direction substantially normal to the longitudinal axis of the coils. This principal is again illustrated with reference to FIGS. 11-14. A two-coil shock absorber 42 has a longitudinal axis “A” and an outer diameter which defines the distance “D1” between a first object 44 and a second object 46. These objects, for example, could be an inner sole plate of a shoe as the first object 42 and the ground reacting through an outer sole plate of the shoe as the second object 44.

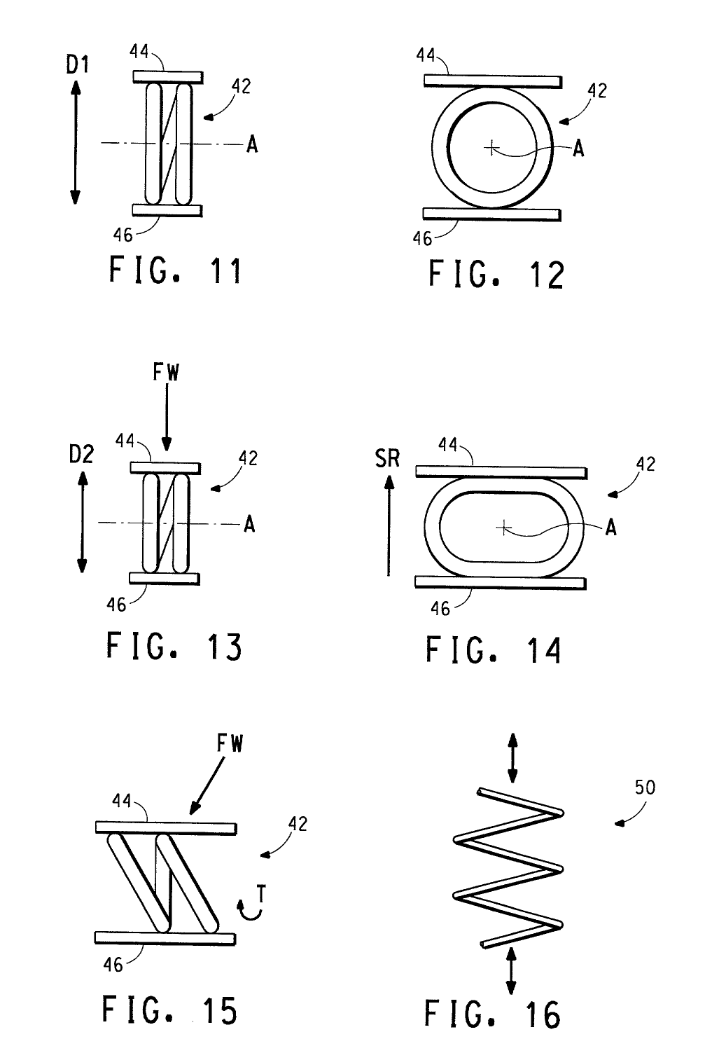

When a load is applied to the shock absorber 42, such as the weight of the wearer striking the ground, as occurs when walking, running or standing, the load is substantially normal or perpendicular to the axis A of the shock absorber 42, as shown by the force vector “FW.” (In the absence of a force in the opposite direction of FW, the structure would merely translate. The ground, while not actively providing an opposite force, creates a reaction force that causes the shock absorber to be compressed between 44 and 46.) This causes the shock absorber 42 to flatten slightly, as shown in FIG. 14, but in so doing, a spring restoration force “SR” is generated that tends to cause the shock absorber to adopt its original shape when the load is removed. The load applied to the shock absorber 42, embodied in force vector FW, causes the distance D1 to be reduced to a shorter distance D2, and the spring restoring force SR causes the distance to return to D1 after removal of the load.

If, on the other hand, the force vector is tilted away from normal, as shown in FIG. 15, a possibility exists to create a restoring force that is generated by the torsional action of the monofilament which creates a torque “T” to cause the shock absorber to return to its original disposition. An example in the footwear structure would be if the wearer stopped suddenly, thereby causing object 44 to translate relative to object 46. At least some of the restoring force is likely to be torsional in this example, although a compressive component is also likely. The combined forces nevertheless cause the shock absorber to either compress, or tilt, or a combination of both. When tilting of the coils occurs, there is likely to be a T component to the restoring force.

Whether by compression of the coil or tilting of the coil, the shock absorbers of the present invention work in ways fundamentally different from conventional shock absorbers, where shock absorption is effected by displacement of the coils relative to each other, i.e., becoming closer when undergoing a longitudinally directed compression force, and becoming further apart when undergoing a longitudinally directed tension force.

While the invention has been described with reference to shock absorption, the coiled structures can be used in basic vibration dampening applications to provide attenuation of even the slightest forced mechanical movements. The present invention can be employed in virtually any environment where vibration pads and bushings have been employed before.

While the aforementioned embodiments, and additional ones that follow, describe structures that resemble coil springs, the loads are applied radially to take advantage of the arch formed at or near the point of impact with the load. When contemplating radially applied loads, the specification herein has described the use of plastic, flexible materials. However, metallic materials could also be employed. Metallic materials can be selected to achieve the desired spring constant or otherwise the desired shock absorbing effect.

Another aspect of the present invention is to make a conventional, axially loaded coil spring from the plastic materials described hereinabove. Referring to FIG. 16, a coil spring 50 is illustrated as receiving loads in the conventional, axial directions shown by the doubled ended directional arrows. This indicates that the load applied to the spring 50 can be either compressive or tension. A significant difference between the spring 50 and a conventional coil spring is that conventional springs are made of metal, such as steel, whereas the spring of the present invention is made of coiled monofilament material such as nylon or polyester or other synthetic resins. The diameter and pitch of the coils can be selected to determine the relative hardness or softness of the spring. Also, the precise material can be selected as another parameter for determining spring stiffness.

When making a normally loaded coil spring, the method of forming the coil can include a molding process, such as by forming a coil-shaped mold and filling the mold with a liquid, plastic material such as nylon or polyester, and then subsequently curing the liquid material. Either thermo-setting or thermo-plastic materials can be used.

Also, a length of pre-formed monofilament can be wrapped around a mandrel to form a coiled structure, and the coils can be set mechanically by a subsequent heating step, or can be held positionally by a binding string, glue line, etc. By way of example, a conventional coil spring, but made of plastic, can be formed by using a process similar to the one used to make the radially or laterally applied-force spring shown in FIG. 5, except that the pitch of the coils would allow for relative movement between adjacent coils, and the support string 22 would have an elastic property so as to permit relative movement of the adjacent coils. Alternatively, the coils could be heated to thermo-set the material into the desired coil shape, without the need for a support string 22.

Another aspect of the present invention is to use the radially loaded coil structures to form piston-type shock absorbers. Referring now to FIGS. 17 and 18, a shock absorber 52 includes a body 54 having a longitudinal axis, first and second opposite axial ends and a sidewall between the first and second opposite axial ends. The body can be made of any suitable material. At least one coiled structure 56, having a longitudinal axis, is disposed within the body 54 with the longitudinal axis of the coiled structure 56 being substantially perpendicular to the longitudinal axis of the body 54.

A piston 58 is guided for axial movement by, and is disposed at least partially within, the body 54 at one of the first and second opposite axial ends. An abutment 60 is disposed at the other of the first and second opposite axial ends so that the at least one coil structure 56 is constrained between the piston and the abutment. When a force is applied to either the piston 58 or the abutment 60, the at least one coil structure 56 is caused to flex and thus provide a spring restoring force. As illustrated in FIG. 17, the at least one coiled structure includes a plurality of straight coiled structures arranged in longitudinally spaced stages within the body 54. Each stage is separated by a partition 62 which functions to keep the individual coils of each coiled structure from interfitting between the coils of adjacent coiled structures. Although each stage can include just one linear coiled structure, the illustrated embodiment shows that each stage includes two linear coiled structures. The number of coiled structures in each stage, as well as the number of stages, can be selected according to the particular application and the desired spring force.

In the embodiment shown in FIGS. 17 and 18, the piston 58 is guided by the body 54 for reciprocal movement within the body. The abutment 60 may be fixed, such as an end cap for the body, or may be movable such as the case where the abutment is another piston, thus rendering the device “double action.” Any suitable means can be employed to mount the abutment or the piston in the body. If double ended, the piston 58 and abutment 60 can be disposed between an applied load and a protected structure. By example, the abutment 60 can be fixedly connected to a frame of an automobile, and the piston can be fixedly connected to a bumper. When an impact is applied to the bumper, the piston moves inwardly (as shown by directional arrow C) to compress the straight coiled structures 56. The body 54 may also be sealed so as to take advantage of pneumatic dampening as the piston 58 moves inwardly; however, the shock absorber 52 may instead rely exclusively on the spring forces generated by compressing the individual coils of each coiled structure. The total amount of travel of the shock absorber is additive of the travel allowed each stage. Thus, to increase the amount of travel, the number of stages is increased. Also, to render the spring force non-linear, the stages can have different diameter coils, or different pitches, or different materials, or combinations of all of these parameters, so that each stage can have a different spring force.

The embodiment of FIGS. 17 and 18 illustrate a body of rectangular section. FIGS. 19 and 20 illustrate a variant shock absorber 64 in which the body 66 is circular in cross section. Each stage includes a spiral wound coiled structure 68, and each stage is separated by a partition 69. The spiral wound coiled structures are formed by simply taking a linear coiled structure and bending them into a spiral formation. This is easily done since the preferred materials are flexible, whether using plastic or steel.

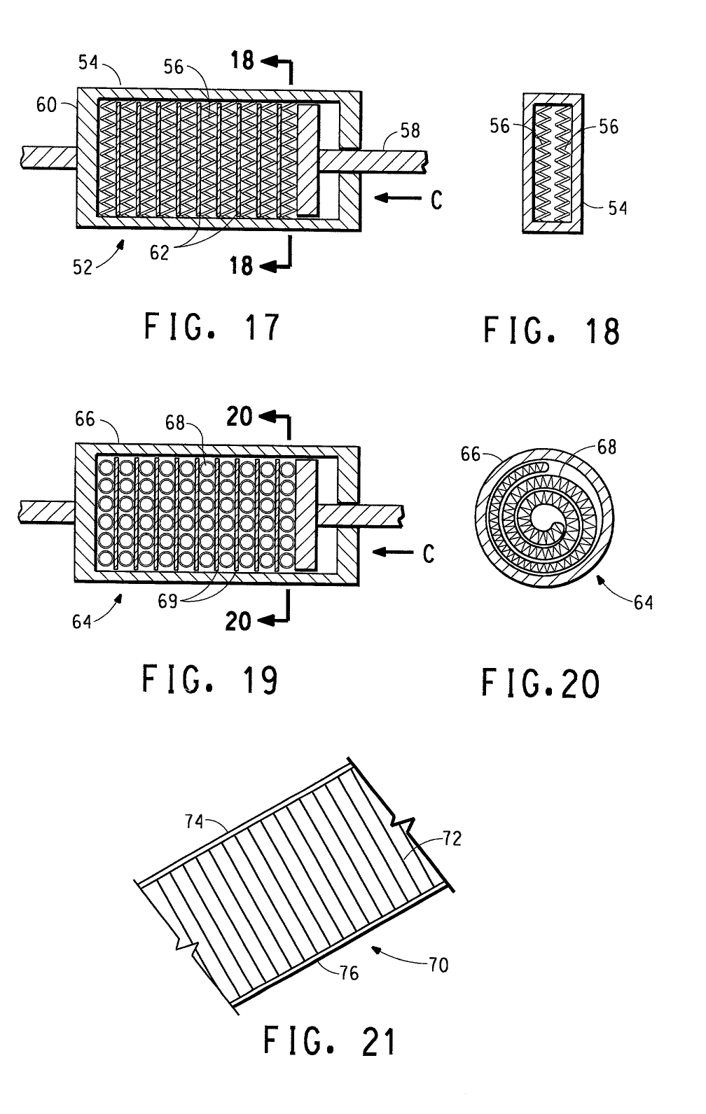

While the aforementioned embodiments describe shock absorbing structures that are basically circular in end view or radial section, the invention can employ materials that have any general arch-type configuration. For example, a ladder-type structure has been described in co-pending application Ser. No. 09/247,093 filed Feb. 9, 1999, which is incorporated by reference. Referring to FIGS. 21-23, a ladder structure 70 includes a plurality of monofilaments 72 disposed between two base strings 74 and 76. The base strings are bonded to the monofilaments by ultrasonic heating. The monofilaments are preferably made of nylon or polyester, as are the base strings. However, other materials and bonding techniques may be employed.

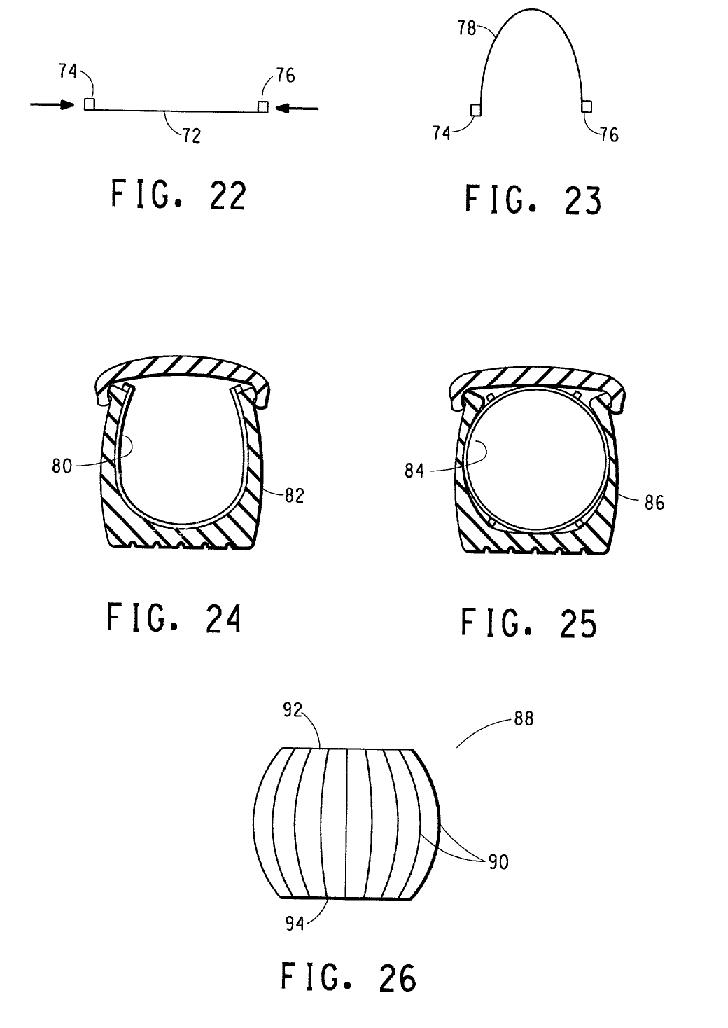

When the base strings 74 and 76 are brought together, as shown by the directional arrows of FIG. 22, the monofilaments 72 bend to form an arch 78, the apex of which is positioned to receive a load. Thus, in any corresponding shock absorbing structure, the arch-shaped ladder structure can be used instead of the coiled structures. To take advantage of the spring force generated by flexing the arch, the base string-ends of the ladder structure should be confined or otherwise connected to a corresponding structure.

In the shock absorbing structure of FIG. 23, the flexible strands are disposed in a parallel array and have substantially co-terminating opposite ends. The base strings 74 and 76 act as means for binding the co-terminating opposite ends together; however, any other suitable means can be employed, including clamps, adhesives, and other structures. The strands are substantially linear when the opposite ends are unconstrained, but strands flex to adopt an arch-shape when the opposite ends are brought together. The strands flex inwardly in response to an applied load, thereby generating a spring restoring force that returns the strands to the arch-shape when the load is removed. The ends can be constrained by attaching them by any suitable means to a structure intended to be protected by the shock absorbing structures.

One example of use for the arch structure is shown in FIG. 24, in which the arch-shaped shock absorber 80 is disposed within a tire 82. In order to assemble the tire, a length of the ladder structure can be selected to extend circumferentially around the inside of the tire 82. The opposite ends of the shock absorber can be attached to the inside of the tire 82 by any suitable means, including adhesives. The embodiment of FIG. 24 is of a tubeless tire, but the concept would be applied equally to a tubed tire. The arched structure would receive the load from the vehicle through the tires, and thus help cushion the ride of the automobile along with the pneumatic cushion provided by inflation of the tires. In the event of a total loss of pressure, or under-inflation of the tire, the arched structure may be sufficient to support the tire so that the vehicle could be operated even when under-inflation would otherwise prevent safe operation. In other words, the arched structures could be stiff or strong enough to keep the tire from becoming flat, and at the same time, the flexibility of the arches will allow the tire to provide a cushioned ride. The tire could be of any type for any vehicle, including bicycles and motorcycles, where flats and under-inflation present particularly acute safety issues.

With respect to tires, the coiled structures described herein could also be used in combination with tires, as shown in FIG. 25. As shown, the coils 84 being of generally circular shape are sized to substantially extend between the tire rim and the radially outward extent of the tire 86, meaning the inside of the tread. To assemble the tire 86, a length of coiled structure is sized so that when it is brought end-to-end, the length corresponds substantially to the circumference of the inner cavity of the tire. As in the arched configuration, the coiled structure can assist shock absorption during normal operation, and can keep the tire from becoming flat in the event of a puncture which might cause rapid pressure loss or even a slow leak.

Another use of the ladder structure is illustrated in FIG. 26, which can be referred to as a “birdcage” shock absorber. The shock absorbing structure 88 includes a plurality of flexible strands 90 which are disposed in a parallel array, as shown in FIG. 21, and have substantially co-terminating first opposite ends and second opposite ends. The ends are bound together by using any suitable means, such as base strings 92 and 94, which correspond to base strings 74 and 76 of FIG. 21.

To form the birdcage, the ladder structure of FIG. 21 is rolled so that the opposite ends of base string 92 are brought together, and the opposite ends of base string 94 are brought together, rather than moving the base string 92 closer to base string 94, which is what occurs when forming the arch of FIG. 23. Essentially, the rolling of the ladder structure, and subsequent joining of the opposite ends of the base strings together, forms a bowed cylinder in which the ends of the cylinder are defined by the opposite base strings, and the side wall is formed by the individual strands.

Thus, the strands 90 are substantially straight when the opposite ends are unconstrained, or prior to rolling; the strands flex slightly outwardly to adopt an arch-shape when the flexible strands are rolled into a loop, wherein the first opposite ends are substantially disposed in a first plane, and the second opposite ends are disposed in a second plane. The first opposite ends of the strands form a first continuous loop, held together by the base string 92, and the second opposite ends form a second continuous loop, held together by the base string 94. The second loop is spaced from the first continuous loop, and the flexible strands flex outwardly in response to a load applied to either or both of the first and second opposite ends.

Though the coils of the springs illustrated herein are circular, other shapes, such as triangular and rectangular, can be manufactured.

While the invention has been described with reference to specific embodiments showing specific products, it is within the scope of the present invention to make any one of several other and various products and articles, including those that do not require flexing or shock absorption. For example, after forming the coiled structures, the structures can be relatively rigid or substantially rigid, so that the articles can be used as supports or components in making other articles.

Although the invention has been described with reference to a particular embodiment, it will be understood to those skilled in the art that the invention is capable of a variety of alternative embodiments within the sprit of the appended claims.

1. A shock absorbing structure comprising:
a body defined by a plurality of adjacent coils, wherein the body has a longitudinal axis, wherein at least some of the coils are resilient and flexible when exposed to a load applied substantially off-axis, and wherein the body is positioned in use so that the coils deflect in directions substantially normal to the longitudinal axis of the body.

2. A shock absorbing structure according to claim 1, wherein the body is made of a continuous length of material, wrapped to form the plurality of adjacent coils.

3. A shock absorbing structure according to claim 2, wherein the coils are substantially circular in shape.

4. A shock absorbing structure according to claim 2, wherein the coils are shaped in one of an oval shape, an ellipse shape, and a polyhedron shape.

5. A shock absorbing structure according to claim 2, wherein the material is selected from the group consisting of polymeric monofilament materials and metals.

6. A shock absorbing structure according to claim 5, wherein the polymeric monofilament material is selected from the group consisting of nylon resins, acetal resins, and polyester resins.

7. A shock absorbing structure according to claim 2, further comprising at least one support member connected to the plurality of coils to thereby assist in maintaining a desired orientation of the coils.

8. A shock absorbing structure according to claim 7, wherein the support member is a string.

9. An article of footwear comprising:
a body having at least a sole portion; and
at least one shock absorber disposed in or near the sole portion, between a wearer's foot and the ground,
wherein the at least one shock absorber is defined at least in part by a plurality of adjacent coils, wherein at least some of the coils are resilient and flexible when exposed to a load applied substantially off-axis, and wherein the at least one shock absorber is positioned in use so that the coils deflect in directions substantially normal to the longitudinal axis of the body.

10. An article according to claim 9, wherein the at least one shock absorber is embedded in foam material.

11. An article according to claim 9, wherein the at least one shock absorber is disposed between at least two layers of the sole portion.

12. An article according to claim 9, wherein the shock absorber is made of a continuous length of material, wrapped to form the adjacent coils.

13. An article according to claim 9, wherein the coils are substantially circular in shape.

14. An article according to claim 9, wherein the coils are shaped in one of an oval shape, and a polyhedron shape.

15. An article according to claim 12, wherein the material is a polymeric, monofilament material.

16. An article according to claim 15, wherein the polymeric monofilament material is selected from the group consisting of nylon, polyester and acetal.

17. An article according to claim 12, further comprising at least one support member connected to the plurality of coils to thereby assist in maintaining a desired orientation of the coils.

18. An article according to claim 17, wherein the at least one support member is a string.

19. An article according to claim 18, wherein the string is a monofilament made of polymeric material.

20. An article comprising:
a length of polymeric monofilament coiled to form a sidewall which defines a body having a central axis.

21. An article according to claim 20, wherein the body is substantially cylindrically shaped.

22. An article according to claim 21, wherein the polymeric monofilament material is selected from the group consisting of nylon, polyester and acetal.

23. A method of using a polymeric monofilament comprising:
forming a coil spring from the monofilament, said coil spring having opposite axial ends which receive, in use, axially applied loads.

24. The method according to claim 23, wherein the forming step comprises providing a length of polymeric monofilament, wrapping the length of polymeric monofilament around a mandrel, whereby the monofilament length adopts a shape corresponding to that of the mandrel, and setting the monofilament length in its shaped condition.

25. The method according to claim 24, wherein the setting step comprises heating the wrapped length of polymeric monofilament.

26. A shock absorber comprising:
a body having a longitudinal axis, first and second opposite axial ends and a sidewall between the first and second opposite axial ends;
at least one coiled structure having a longitudinal axis and being disposed at least partially within the body with the longitudinal axis of the coiled structure being substantially perpendicular to the longitudinal axis of the body;
a piston guided for axial movement by, and disposed at least partially within, the body at one of the first and second opposite axial ends,
an abutment disposed at the other of the first and second opposite axial ends so that the at least one coil structure is constrained between the piston and the abutment, and being radially flexed by a force applied either to the abutment or the piston.

27. A shock absorber according to claim 26, wherein the at least one coiled structure is made from a material selected from the group consisting of a polymer and a metal.

28. A shock absorber according to claim 27, wherein the polymer is selected from the group consisting of nylon, polyester and acetal.

29. A shock absorber according to claim 26, wherein the at least one coiled structure includes a plurality of linear coiled structures arranged in at least one longitudinally spaced stages within the body, wherein each stage is separated by a petition, and wherein each stage includes at least one linear coiled structure.

30. A shock absorber according to claim 26, wherein the at least one coiled structure includes a plurality of spiral wound, coiled structures arranged in longitudinally spaced stages within the body, wherein each stage is separated by a petition, and wherein each stage includes at least one spiral wound, coiled structure.

31. A shock absorber according to claim 30, wherein the body has a shape selected from the group consisting of cylindrical, oval, elliptical, and polygonal

32. A shock absorbing structure comprising:
a plurality of flexible strands disposed in a parallel array and having substantially co-terminating opposite ends;
means for binding the co-terminating opposite ends together;
wherein the strands are substantially linear when the opposite ends are unconstrained, and wherein the strands flex to adopt an arch-shape when the opposite ends are brought together, and wherein the strands flex inwardly in response to an applied load, thereby generating a spring restoring force that returns the strands to the arch-shape when the load is removed.

33. A shock absorbing structure according to claim 32, wherein the strands are made of a material selected from the group consisting of a polymer and a metal.

34. A shock absorbing structure according to claim 33, wherein the polymer is selected from the group consisting of nylon, polyester, and acetal.

35. A shock absorbing structure according to claim 32, wherein the binding strings are made of a material selected from the group consisting of nylon, polyester and acetal.

36. An apparatus comprising:
a tire having an inner cavity and being mountable on a rim, and being inflatable to generate an internal pneumatic force which opposes shock and other loads;
an arched structure extending substantially continuously around the tire in the inner cavity.

37. An apparatus according to claim 36, wherein the arched structure includes a plurality of flexible strands disposed in a parallel array and having substantially co-terminating opposite ends, and means for binding the co-terminating opposite ends together, wherein the strands are substantially linear when the opposite ends are unconstrained, and wherein the strands flex to adopt an arch-shape when the opposite ends are brought together, and wherein the strands flex inwardly in response to an applied load, thereby generating a spring restoring force that tends to return the strands to the arch-shape when the load is removed.

38. An apparatus according to claim 37, wherein the flexible strands are made of a material selected from the group consisting of a polymer and a metal.

39. An apparatus according to claim 38, wherein the polymer is selected from the group consisting of nylon, polyester and acetal.

40. An apparatus according to claim 36, wherein the arched structure includes a body made of a continuous length of material, wrapped to form the plurality of adjacent coils, and wherein the coils extend substantially between the rim and an inner side of a tread area of the tire.

41. A shock absorbing structure comprising:
a plurality of flexible strands disposed in a parallel array and having substantially co-terminating first opposite ends and second opposite ends; and
means for binding the co-terminating opposite ends together,
wherein the strands are substantially linear when the opposite ends are unconstrained,
wherein the first opposite ends are substantially disposed in a first plane, and the second opposite ends are disposed in a second plane, and the first opposite ends form a first continuous loop, and the second opposite ends form a second continuous loop which is spaced from the first continuous loop, and
wherein the strands flex in response to a load applied to either or both of the first and second opposite ends, thereby generating a spring restoring force that returns the strands to an original position when the load is removed.

42. A shock absorbing structure according to claim 41, wherein the strands are made of a material selected from the group consisting of a polymer and a metal.

43. A shock absorbing structure according to claim 42, wherein the polymer is selected from the group consisting of nylon, polyester and acetal.

44. A shock absorbing structure according to claim 41, wherein the binding means includes a first base string connected to the first opposite ends of the strands, and a second base string connected to the second opposite ends of the strands.

45. A shock absorbing structure according to claim 41, wherein the strands flex slightly to adopt an arch-shape when the flexible strands are rolled into a loop.
